(19) United States
(12) Patent Application Publication
(10) Pub. No.: US 2024/0247705 A1
(43) Pub. Date: Jul. 25, 2024

(54) GEARING MECHANISM TO TRANSFER OSCILLATING ROTATION INTO UNIDIRECTIONAL ROTATION

(71) Applicant: JACK COPLEN, FOLSOM, CA (US)

(72) Inventor: JACK COPLEN, FOLSOM, CA (US)

(21) Appl. No.: 18/414,360

(22) Filed: Jan. 16, 2024

Related U.S. Application Data
(63) Continuation of application No. 18/099,431, filed on Jan. 20, 2023, now abandoned.

(51) Int. Cl. F16H 3/10; F16H 3/089; F16H 3/14

(52) U.S. Cl. CPC F16H 3/10; F16H 3/089; F16H 3/145; F16H 2003/0822

(57) ABSTRACT

The present invention discloses a mechanism that transfers an oscillating rotation into a unidirectional rotation. In one embodiment, the present invention discloses a spur gearing mechanism using spur gears. In another embodiment, the present invention discloses a bevel gearing mechanism using bevel gears, which reduces the total number of gears in comparison to the spur gearing mechanism.

### CROSS-REFERENCE TO RELATED APPLICATIONS

This application claims benefit under 35 U.S.C. § 119 of U.S. Non-Provisional Application having Ser. No. 18/099,431 filed Jan. 20, 2023, which is hereby incorporated by reference herein in its entirety.

### FIELD

The present invention generally relates to power transmissions by using gearing mechanisms. More specifically, the present invention relates to the conversion of power at an input, preferably rotational, to power at an output, preferably unidirectional using a gearing mechanism disclosed herein. The gearing mechanism transfers an oscillating rotation into a unidirectional rotation.

### BACKGROUND

Generally, mechanical energy is resolved into components of force and velocity. In the case of rotational force, these are in the form of rotational velocity and torque. Power transmissions typically convert energy from a range of angular velocities and a range of torque to output energy at a different range of angular velocities. Conservation of energy dictates that the input speed and torque resolve to the same energy as the output energy, minus energy conversion losses. For example, in some of the vehicles such as marine vessels, land vehicles, or the like subjected to extrinsic useless oscillation motions such as those of ocean waves and the like, a mechanism is provided that is fixedly mounted in the vehicles to convert the extrinsic oscillation motions into a useful torque for driving the desired instrument by producing a torque giving each of their horizontal axles a unidirectional rotation. However, in such a conventional mechanism, since the horizontal axles are individually driven, it is difficult to combine both unidirectional rotations of the horizontal axles into a single powerful driving force or torque. In other words, in the conventional mechanism, the unidirectional rotations of the horizontal axles remain uncombined to fail to produce a powerful driving force or torque. To resolve the above disadvantage, there is another conventional mechanism that is provided with a pair of gears. These gears are rotatably mounted on a common axle through a pair of unidirectional rotating means. Further, these gears are oppositely disposed from each other, between which another pair of gears are fixedly mounted on a torque-output shaft that is interposed to mesh with both pairs of gears mounted on the common axle. The one-way clutches enable the pair of gears to rotate on the common axle in opposite directions counter to each other, which makes it possible to rotate the torque-output shaft in only one direction when the common axle is rotatably driven under the influence of extrinsic oscillation motions to which the apparatus is subjected. Since the extrinsic oscillation motions vary in amplitude, direction and cycle every moment, the gears of the conventional mechanism also vary every moment to make it difficult to convert the extrinsic oscillation motions into a constant powerful driving force or torque.

Considering the above-mentioned background, there exists a need for a solution that solves the abovementioned problems and provides a seamless mechanism for the conversion of power at an input, which is preferably rotational, to power at an output, which is preferably unidirectional.

### SUMMARY

It will be understood that this disclosure is not limited to the systems and methodologies particularly described herein, as there can be multiple possible embodiments of the present disclosure which are not expressly illustrated in the present disclosure. It is also to be understood that the terminology used in the description is to describe one or more versions or embodiments that are particular to the present invention only and is not intended to limit the scope of the present disclosure.

It is an object of the present invention to provide a mechanism that transfers an oscillating rotation into a uni-directional rotation. The rotational movement may correspond to a clockwise or anti-clockwise movement. The unidirectional movement may correspond to a forward movement or a backward movement.

One objective of the present invention is to provide a spur gearing mechanism using spur gears. There is provided a shuttle for the gearing mechanism. In an embodiment, the shuttle is rotationally fixed to an output shaft and able to translate along the output shaft. The shuttle has a set of pawls that engage with a first output gear. In an embodiment, when the first output gear rotates in a first direction, the first output gear engages the shuttle to rotate the first output gear. In another embodiment, when the first output gear rotates in the opposite direction, the first output gear causes the shuttle to translate along an input shaft and to engage with a second output gear. The second output gear engages the shuttle to rotate. The two output gears are then connected through transmission gears to the output shaft. The result is that any rotation of input gears may cause a resulting rotation of the output shaft. The output shaft rotates in only one direction. The benefit of the disclosed design is that frictional losses are extremely low, and power seems to be transferred highly efficiently.

Another objective of the present invention is to provide a bevel gearing mechanism using bevel gears, which reduces the total number of gears in comparison to the spur gearing mechanism. In some embodiments, the bevel gearing mechanism may be better than the spur gearing mechanism. This is because with the spur gearing mechanism, there is 5 gears, meanwhile with bevels there is only 3 gears, therefore slightly less friction because of fewer gears. Also, the bevel gearing mechanism has the potential benefit of the output shaft being perpendicular to the input shaft, rather than parallel like in the spur gearing mechanism. This can allow for changes to orientation based on the use. Now multiple devices can all be connected through a central axle and combine their power to tum something.

The above-described features and other advantages realized through the techniques of the present disclosure will be better appreciated and understood with reference to the following detailed description and drawings. Additional features and advantages are realized through the techniques of the present invention as described below.

### BRIEF DESCRIPTION OF THE DRAWINGS

FIG. 1 illustrates a side perspective view of a spur gearing mechanism for transferring an oscillating rotation into a unidirectional rotation, according to an exemplary embodiment of the present invention.

FIG. 2 illustrates another side perspective view of the spur gearing mechanism for transferring the oscillating rotation into the unidirectional rotation, according to an exemplary embodiment of the present invention.

FIG. 3 illustrates a front view of the spur gearing mechanism for transferring the oscillating rotation into the unidirectional rotation, according to an exemplary embodiment of the present invention.

FIG. 4 illustrates a top perspective view of the spur gearing mechanism for transferring the oscillating rotation into the unidirectional rotation, according to an exemplary embodiment of the present invention.

FIGS. 5a and 5b illustrate a top view of a bevel gearing mechanism for transferring an oscillating rotation into a unidirectional rotation, according to an exemplary embodiment of the present invention.

FIGS. 6a and 6b illustrate a top perspective view of the bevel gearing mechanism for transferring an oscillating rotation into a unidirectional rotation, according to another exemplary embodiment of the present invention.

Further areas of applicability of the present invention will become apparent from the detailed description pro-vided hereinafter. It should be further understood that the detailed description of exemplary embodiments is intended for illustration purposes only and is, therefore, not intended to necessarily limit the scope of the present invention.

### DETAILED DESCRIPTION

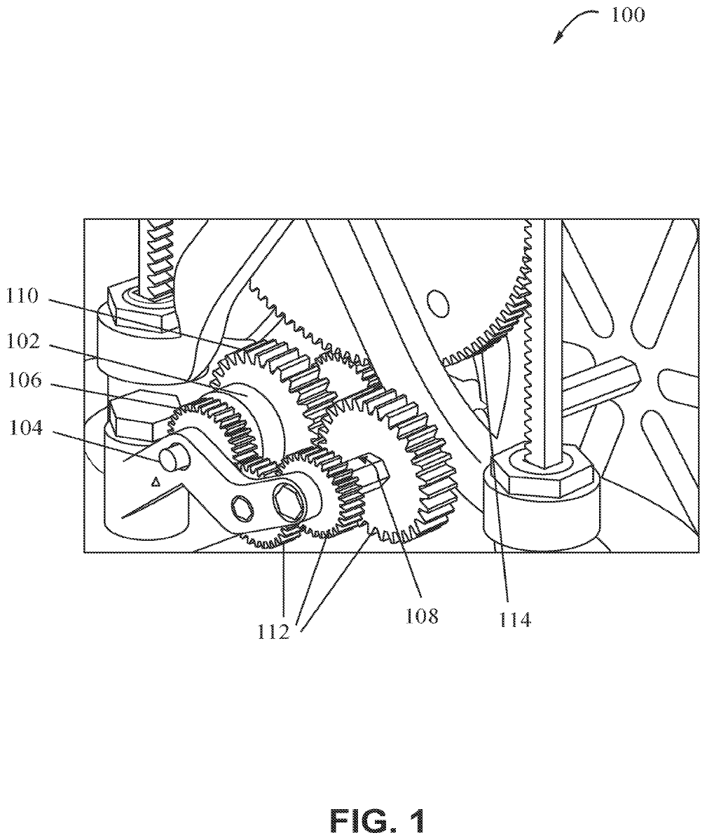

The present invention relates generally to mechanics, and more specifically, to one or more gearing mechanisms for transferring an oscillating rotation into a unidirectional rotation. Specific details of certain embodiments of the present invention are outlined in the following description, in conjunction with FIGS. 1, 2, 3, 4, 5a, 5b, 6a, and 6b, to provide the understanding of various embodiments. The present invention may have additional embodiments, may be practiced without one or more of the details described for any embodiment, or may have any detail described for one particular embodiment practiced with any other detail described for another embodiment.

FIG. 1 illustrates a side perspective view of a spur gearing mechanism 100 for transferring an oscillating rotation into a unidirectional rotation, according to an exemplary embodiment of the present invention. The gearing mechanism 100 includes a shuttle 102, an output shaft 104, a first output gear 106, a second output gear 110, a transmission gears 112, and input gears 114.

In an embodiment, the shuttle 102 is a gearing component that engages with an active gearset based on a direction of input rotation. The shuttle 102 is rotationally fixed to the output shaft 104. In a specific example, shuttle 102 is rotationally fixed to the output shaft 104 between the first output gear 106 and the second output gear 110. Thus, as shown in FIG. 1, the shuttle 102, the first output gear 106, and the second output gear 110 are rotationally fixed to the output shaft 104 such that the shuttle 102 is between the first output gear 106 and the second output gear 110. The shuttle 102 may be made up of any suitable material for a given application. For example, the mechanism might be steel in a bicycle hub, polymer for an ocean wave mechanism, brass for a watch mechanism, or the like. The first output gear 106 may rotate in the first direction 108, or a direction opposite to the first direction 108.

Most modem gearboxes are used to increase torque while reducing the speed of a prime mover output shaft (such as the output shaft 104). This means that the output shaft 104 of a gearbox rotates at a slower rate than the input shaft, and this speed reduction produces a mechanical advantage, increasing torque. A gearbox can be set up to do the opposite and provide an increase in shaft speed with a reduction of torque. Some of the simplest gearboxes merely change the physical rotational direction of power transmission.

A gear (such as the first output gear 106, the second output gear 110, the transmission gear 112, or the input gear 114) is a rotating machine part having cut teeth or, in the case of a cogwheel, inserted teeth (called cogs), which mesh with another toothed part to transmit torque. Geared devices can change a power source's speed, torque, and direction. Gears almost always produce a change in torque, creating a mechanical advantage, through their gear ratio, and thus may be considered a simple machine. The teeth on the two meshing gears all have the same shape. Two or more meshing gears, working in a sequence, are called a gear train or a transmission. A gear can mesh with a linear toothed part, called a rack, producing translation instead of rotation.

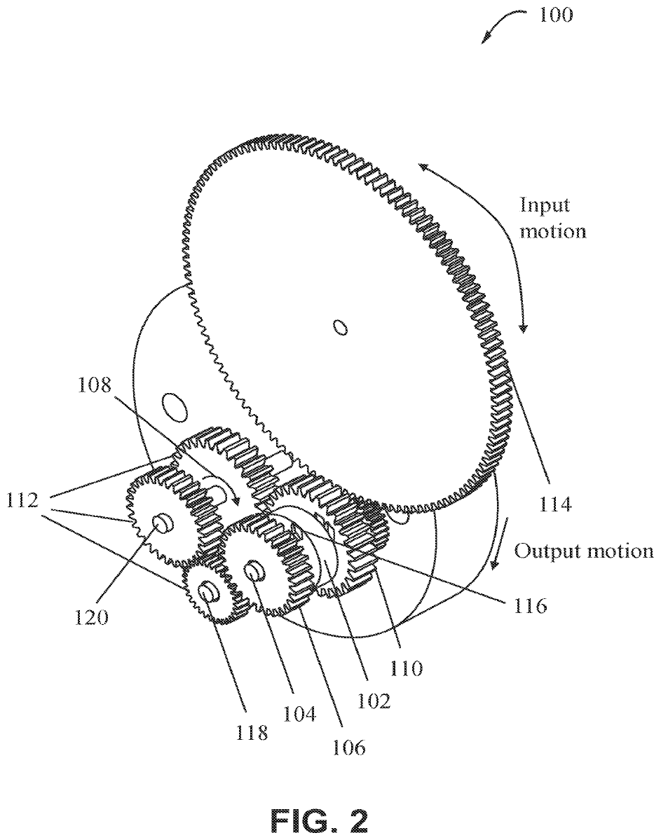

FIG. 2 illustrates another side perspective view of the spur gearing mechanism 100 for transferring the oscillating rotation into the unidirectional rotation, according to an exemplary embodiment of the present invention. The gearing mechanism 100 includes the shuttle 102, the output shaft 104, the first output gear 106, the second output gear 110, the transmission gears 112, and the input gears 114. The shuttle includes pawls (i.e., teeth) 116. The pawls 116 are used for engaging with the first output gear 106.

As shown in FIG. 2, the shuttle 102, the first output gear 106, and the second output gear 110 are rotationally fixed to the output shaft 104 such that the shuttle 102 is placed between the first output gear 106 and the second out-put gear 110. The pawls 116 of the shuttle 102 are used for engaging with the first output gear 106. Similarly, one trans-mission gear 112 is rotationally fixed to another shaft 118 and the remaining two transmission gears 112 are rotationally fixed to another shaft 120. Further, as shown in FIG. 2, the teeth of the first output gear 106 engage or mesh with the teeth of two transmission gears 112. Further, as shown in FIG. 2, the teeth of the second output gear 110 engage or mesh with the teeth of the transmission gear 112. In an embodiment, when the shaft 120 rotates in the first direction 108, two transmission gears 112 also rotates in the same first direction 108, which in turn causes the one transmission gear 112 to rotate in a direction opposite to the first direction 108. The rotation of the one transmission gear 112 in the opposite direction causes the first output gear 106 to rotate in the first direction 108, which in tum causes the second output gear 110 to rotate in the direction opposite to the first direction 108. As a result, the shuttle 102 rotates in either the first direction 108, the opposite direction, or linearly along the output shaft 104.

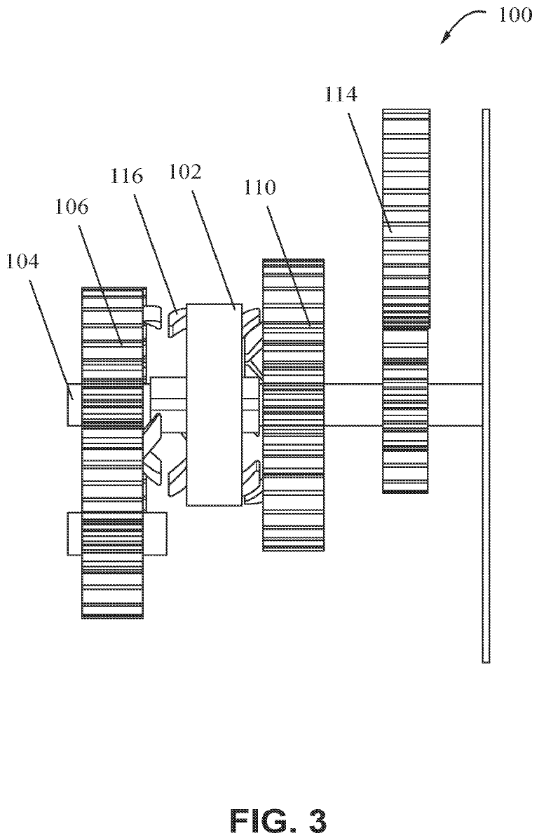

FIG. 3 illustrates a front view of the spur gearing mechanism 100 for transferring the oscillating rotation into the unidirectional rotation, according to an exemplary embodiment of the present invention. The gearing mechanism 100 includes the shuttle 102, the output shaft 104, the first output gear 106, the second output gear 110, and the input gears 114. The shuttle includes the pawls (i.e., teeth) 116. The pawls 116 are used for engaging with the first out-put gear 106. A pawl is used in combination with gear in socket wrenches, bicycle freehubs, winches, and many other applications. Pawls may be used on extension ladders to prevent the ladder sections from sliding relative to each other. Pawls may be used on table saws to grip the work-piece and prevent kickback.

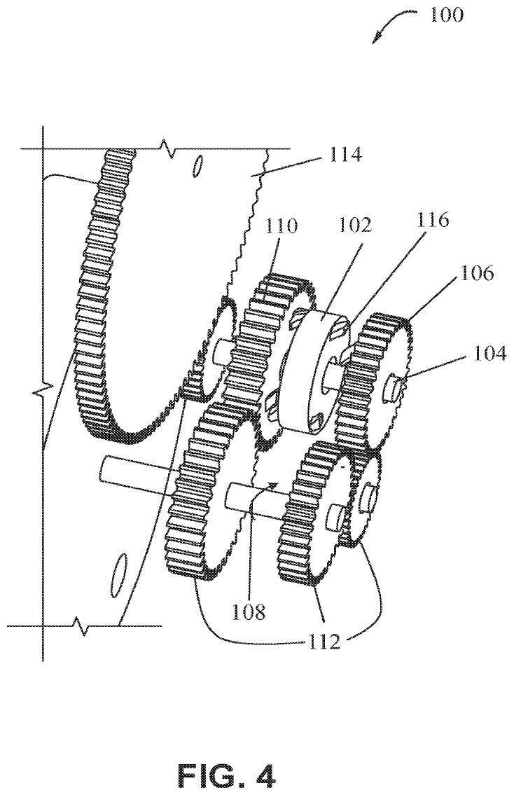

FIG. 4 illustrates a top perspective view of the spur gearing mechanism 100 for transferring the oscillating rotation into the unidirectional rotation, according to an exemplary embodiment of the present invention. The gearing mechanism 100 includes shuttle 102, the output shaft 104, the first output gear 106, the second output gear 110, the transmission gears 112, and the input gears 114. The shuttle includes the pawls (i.e., teeth) 116.

The present invention discloses the gearing mechanism that transfers the oscillating rotation into the unidirectional rotation. Such transfer occurs through a sequence of gearing that is in constant mesh arrangement as shown in FIG. 1, FIG. 2, FIG. 3, and FIG. 4. Here, the key component is the shuttle 102 that engages with the active gearset based on the direction of input rotation. The key to the gearing mechanism is the shuttle 102 which is rotationally fixed to the output shaft 104 and can translate along the output shaft 104. Shuttle 102 has pawls 116 that engage with the first output gear 106. The first output gear 106, if rotating in the first direction 108 (i.e., a clock-wise direction), engages the shuttle 102 to rotate the first output gear 106. The first output gear 106, if rotating in the opposite direction (i.e., an anti-clockwise direction), causes the shuttle 102 to translate along the input shaft and to engage with the second output gear 110 that engages the shuttle 102 to rotate. The two output gears 106 and 110 are then connected through the transmission gear 112 to the out-put shaft 104. Note that the transmission gear 112 is different between the first and second output gears 106 and 110 such that both output gears cause rotation of the output shaft 104 in the same direction. This implies that the first output gear 106 goes through one transmission gear 112, but the second output shaft 110 goes through two transmission gears 112. The result is that any rotation of the input gears will cause a resulting rotation of the output shaft 104. The output shaft 104 may only rotate in one direction (i.e., the clockwise direction). The benefit of the design is that frictional losses are extremely low, and power seems to be transferred highly efficiently.

In a few embodiments, the shuttle 102 resides on the output shaft 104 and rotates only unidirectionally. In alternative embodiments, the shuttle 102 may reside on the input shaft and be subject to oscillating rotation, but through the sequence of gears, the power is transferred to the output shaft 104 which rotates only in a single direction. The pre-sent invention can be further developed such that the gearing mechanism 100 has at least one element with direction-dependent or controllably variable transmission of an oscillating movement into a unidirectional one-rotational movement of the output. Such unidirectional is, therefore, able to filter only one particular direction of movement from the oscillating motion and transmitted it to the output, while is switched in the opposite direction of movement in a free-wheeling state to prevent reverse rotation of the output or an output element. The gearing mechanism 100 may be characterized by the shuttle 102 with pawls 116 for direction-dependent or controllably variable transmission of an oscillating motion in a unidirectional rotational movement of the output, wherein the two transmission elements are oriented or controlled such that they each only record and transmit motion in one direction but are set to different directions of the oscillating motion and implement them in the same rotational direction of the output.

The present invention discloses a way of capturing power from ocean waves, though there are many other possible applications, such as personal locomotion, or any other situation where it is desirable to convert random motion into a unidirectional rotation. Other known applications may include bicycle freewheel mechanism, ocean wave power capture, or mechanical watch automatic winding mechanism. Therefore, shuttle 102 may be made up of any suitable material for a given application. For example, the mechanism might be steel in a bicycle hub, polymer for an ocean wave mechanism, brass for a watch mechanism, or the like. Shuttle 102 is in fixed rotation with the output shaft 104, but it can also slide along the output shaft 104. The input gears rotate independently from the output shaft 104.

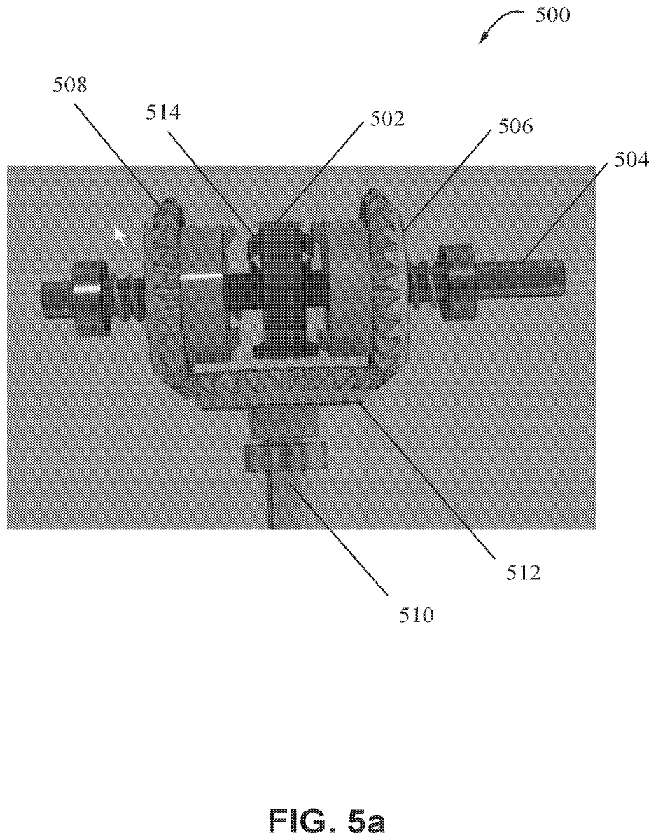

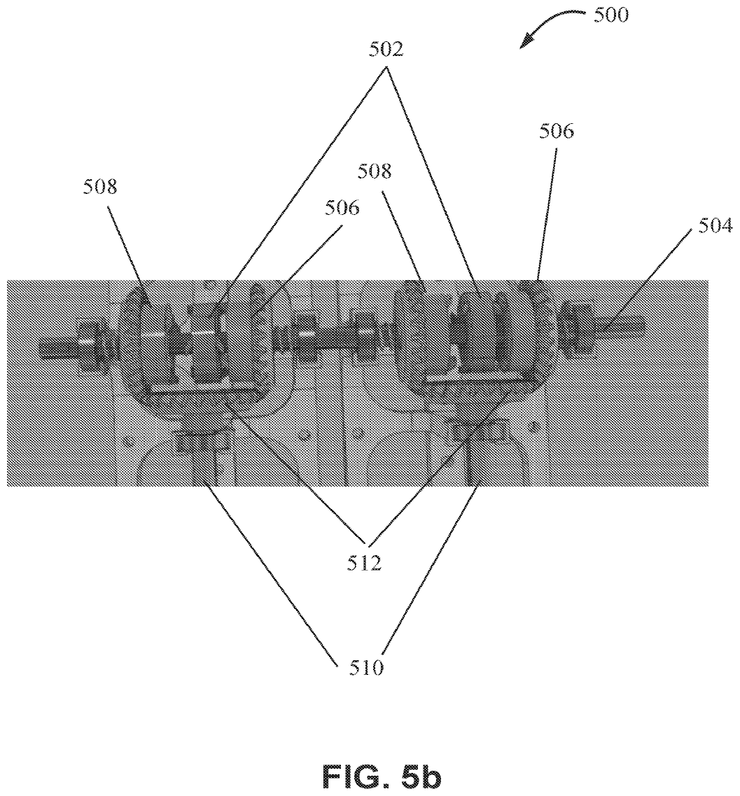

FIGS. 5a and 5b illustrate a top view of a bevel gearing mechanism 500 for transferring an oscillating rotation into a unidirectional rotation, according to an exemplary embodiment of the present invention. The gearing mechanism 500 includes a shuttle 502, an output shaft 504, a first output gear 506, a second output gear 508, an input shaft 510, and an input gear 512. The shuttle 502 includes pawls (i.e., teeth) 514. Pawls 514 are used for engaging with the first output gear 506 and the second out-put gear 508. The output shaft 504 includes the first output gear 506 and the second output gear 508 and the shuttle 502 is in between the first output gear 506 and the second output gear 508 on the output shaft 504. Input shaft 510 includes the input gear 512, as shown, which engages with the first output gear 506 and the second output gear 508.

The bevel gearing embodiment may be the best configuration for limiting friction, as the blue bevel gear is the input gear 512 and the green and yellow gears (i.e., the first output gear 506 and the second output gear 508) rotate freely along the output shaft 504. Based on pawls 514 in the middle, having teeth going in just one direction, the rotation will be toward that direction. The coils on either end of the bevel are used as a spring to push it forward toward the pawl 514, but also if the bevels are aligned so that both teeth touch the pawl 514, it will not have enough room for the pawl 514 to continue spinning, so the spring pushing the gear is used so that when this configuration happens, the pawl 514 will simply push one or both of the bevel gears back slightly so that it can continue to spin uncoupled from those bevels. Also, the spring lightly pushes the bevel forward so that there is no chance that the pawl 514 will be completely in the middle of the bevels and it doesn't engage with the teeth of either bevel. When the flywheel is spinning, and it spins faster than the input gear 512 is turning then the pawl 514 may continue spinning with very little friction loss, as it can freely rotate and bounce back and forth when the flywheel is turning. This configuration, as well as others, may offer interesting conclusions based on how they're set up.

In FIG. 5b, one can see a configuration where multiple devices can be connected through a shared middle axle (teal) 504. This could lead to some interesting implications: For example, in the case of harnessing wave energy, let's say an individual has multiple buckets where waves are going up and down, and each bucket connects to one of the many devices connected to this long axle. Therefore, when one wave is coming in or out and air pressure is captured by one of the bucket devices, it will be transferred through the middle axle to an alternator or flywheel. When no wave is going up and down and no air pressure is produced, the device will be idle, and the pawl will simply slide back and forth as the flywheel spins. When there is an insufficient rotation of the blue bevel in comparison to how fast the flywheel spins, it disconnects. For example, there could be 30 devices all connected through a central middle axle to the flywheel or alternator. And only the devices where waves are actively pushing air in or sucking it out may connect through the pawl to the central axle and create power, while those without waves coming in or out will be devices that decouple from the middle axle until they are able to contribute. So, in this example, the alternator or flywheel is connected to all the devices instead of each device having an alternator or flywheel that gives power to a grid such as in a windmill farm. This configuration may also work as a windmill, where if you had giant funnels on a windy mountain, those could push air into the device and then all the devices connected through a central axle may tum a giant alternator.

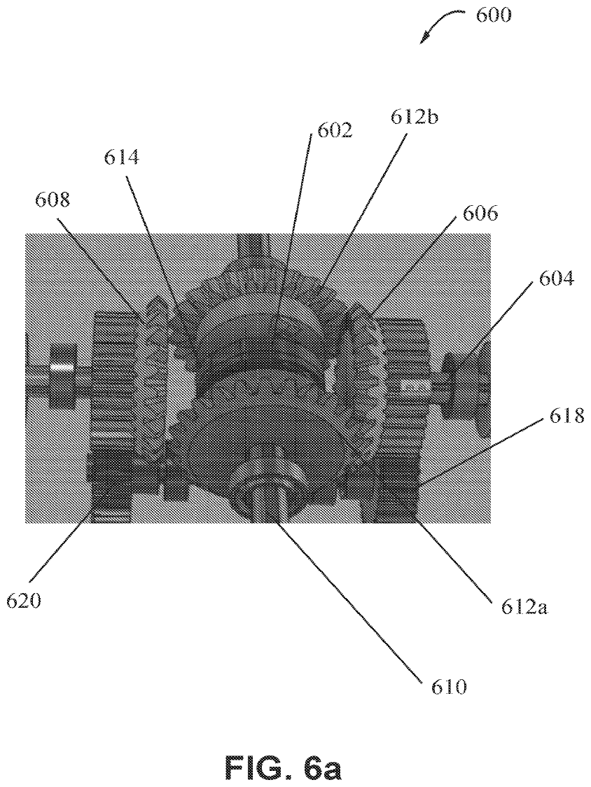

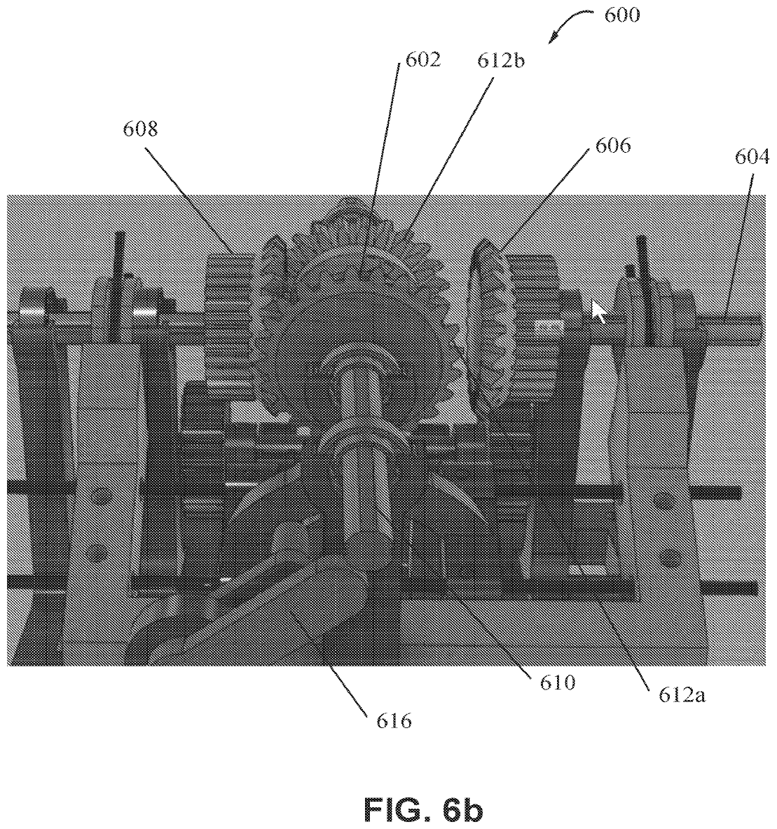

FIGS. 6a and 6b illustrate a top perspective view of the bevel gearing mechanism 600 for transferring an oscillating rotation into a unidirectional rotation, according to another exemplary embodiment of the present invention. The gearing mechanism 600 includes a shuttle 602, an out-put shaft 604, a first output gear 606, a second output gear 608, an input shaft 610, a first input gear 612a and a second input gear 612b. The shuttle 602 includes pawls (i.e., teeth) 614. The pawls are used for engaging with the input gears 612a and 612b. The output shaft 604 includes the first output gear 606 and the second output gear 608. The shuttle 602 is in between the input gears 612a and 612b on the input shaft 610. The gearing mechanism 600 further includes lever 616. This lever 616 may be operated to change the direction of rotation of the output gears 606 and 608. For example, when the lever 616 is in a first position and the input gears 612a and 612b on the input shaft 610 are rotating in a clockwise or anti-clockwise direction, then the output gears 606 and 608 are configured to rotate in a clockwise direction. However, when the lever 616 is in a second position and the input gears 612a and 612b on the input shaft 610 are rotating in a clockwise or anti-clockwise direction, then the output gears 606 and 608 are configured to rotate in an anti-clockwise direction.

As shown, the input axle 610 is grey, and the green and yellow bevels 612a and 612b are rigidly attached. When the bevels 612a and 612b spin, then it engages with one or both of the blue bevel gears 606 and 608. In this configuration, if both blue bevel gears were attached to the input bevels at the same time, the two blue bevels would spin in opposite directions. To negate this opposite-direction movement, two dark orange gears 618 and 620 are placed underneath which engage with both blue bevel gears 606 and 608 so that their direction is the same. With this configuration, there are two orange holders rigidly attached to the bevel axle. There is a gap that allows for a rod to lay in between the faces of this holder. The rods which go through the orange holder connect to a larger orange carriage, which can be turned right or left, and that movement will shift the blue bevels back and forth, so that this carriage alternates which blue bevel is engaged with the pawl mechanism. The lever 616, which is green in color as shown, is connected by a spring to the orange carriage. When this lever 616 is turned to the right, it will pull the carriage right, therefore, the right bevel will be moved further right, disengaging it from the mechanism and the left bevel will be shifted to the right by way of the rod pulling it, and it will now be the one engaging with the mechanism. This creates an ability to shift the rotational direction of the output shaft clockwise or anti-clock-wise based on the user's choice.

As an application of the disclosed embodiments, the bevel gearing mechanism or the spur gearing mechanism may be used for a bicycle, where a user can pedal backward and forward and go forward. Also, there may be an added benefit as the pawl shuttling back and forth when disengaged may likely lead to less loss from friction compared to a typical ratchet mechanism found on bikes when coasting.

Thus, the present invention is well adapted to carry out the objects and attain the ends and advantages mentioned as well as those inherent therein. While preferred embodiments of the present invention have been illustrated for the purpose of the present disclosure, changes in the arrangement and construction of parts and the performance of steps can be made by those skilled in the art, which changes are encompassed within the scope and spirit of the present invention as defined by the appended claims. Although particular embodiments of the present invention have been described in detail for purposes of illustration, various modifications and enhancements may be made with-out departing from the spirit and scope of the present invention.

What is claimed is:

1. A device for uni-directional output, comprising:
a first shaft configured to rotate either clockwise or counter-clockwise;
a first gear coupled to the first shaft;
a second gear coupled to the first shaft;
a shuttle coupled to the first shaft and positioned between the first gear and the second gear, wherein:
the shuttle is configured to engage the first gear when the first shaft is rotated clockwise,
the shuttle is configured to engage the second gear when the first shaft is rotated counter-clockwise; and
a second shaft interchangeably coupled to the first gear and the second gear, wherein the second shaft is configured to rotate in only one direction when engaged by either the first gear or the second gear.

2. The device of claim 1, further comprising a set of pawls configured to couple the first gear to the shuttle when the first shaft is rotated clockwise.

3. The device of claim 2, wherein the set of pawls are configured to couple the second gear to the shuttle when the first shaft is rotated counterclockwise.

4. The device of claim 1, the shuttle is configured to slide along the input shaft to engage either the first gear or the second gear.

5. A device, comprising:
an input shaft configured to rotate in either a first direction or a second direction, wherein the second direction is opposite the first direction;
a first gear coupled to the input shaft;
an output shaft;
a first intermediate element coupled between the first gear and the output shaft;
a second gear coupled to the input shaft;
a second intermediate element coupled between the second gear and the output shaft;
a shuttle positioned between the first gear and the second gear;
a first set of pawls on a first side of the shuttle,
a second set of pawls on a second side of the shuttle;
a third set of pawls on the first gear, in alignment to engage the first set of pawls on the shuttle,
a fourth set of pawls on the second gear in alignment to engage the second set of pawls on the shuttle, wherein:
in response to the input shaft being rotated in the first direction, the third set of pawls on the first gear engages the first set of pawls on the shuttle, and the first intermediate element rotates the output shaft in a first output direction, and
in response to the input shaft being rotated in the second direction, the fourth set of pawls on the second gear engages the second set of pawls on the shuttle, and the second intermediate element rotates the output shaft in the output direction.

6. The device of claim 5, further comprising ends of the first set of pawls on the shuttle and ends on the third set of pawls on the first gear, wherein the ends of the first set of pawls point inward and in an opposite direction of the ends on the third set of pawls.

7. The device of claim 5, wherein the first intermediate element includes a third gear on the output shaft configured to engage with the first gear and rotate in a direction opposite the first gear.

8. The device of claim 7, wherein:
the second intermediate element includes a fourth gear on the output shaft and a fifth gear disposed to engage the second gear and the fourth gear,
the fifth gear is configured to rotate in a direction opposite the second gear, and
the fourth gear is configured to rotate in a direction opposite the fifth gear and in a same direction as the second gear.

9. The device of claim 5, wherein the first set of pawls on the shuttle point in a direction opposite the second set of pawls on the shuttle.
